(19) United States
(12) Patent Application Publication
(10) Pub. No.: US 2011/0120021 A1
(43) Pub. Date: May 26, 2011

(54) Door Assembly

(76) Inventor: Choo Siong Lim, Singapore (SG)

(21) Appl. No.: 13/054,525

(22) PCT Filed: Jul. 9, 2009
(86) PCT No.: PCT/SG2009/000244

§ 371 Date: Jan. 17, 2011

(30) Foreign Application Priority Data
Jul. 16, 2008 (SG) 200805331-6

(51) Int. Cl. E06B 3/36; E05D 7/00

(52) U.S. Cl. 49/399; 49/401

(57) ABSTRACT

According to an aspect of the invention, there is provided a door assembly (200), comprising, in combination, a door frame (220) suitable for receiving a door panel (210), the door frame (220) having a door jamb (221) at which a door panel (210) is received, the door jamb (221) comprising a lip (222) extending perpendicularly from an end portion of the door jamb, a pivoting member (230) onto which the door panel (210) is pivotally connectable, wherein the pivoting member (230) is attached to the lip (222) of the door jamb (221).

### FIELD OF THE INVENTION

The present invention relates to a door assembly. In particular, the present invention relates to a door assembly having a door attached to a doorjamb or frame with a pivoting member.

### BACKGROUND

Doors are commonly attached to doorjambs or frames by hinges. A conventional hinge includes a pair of hinge plates each having a series of knuckles along one edge. The knuckles of the two hinge plates are interleaved to define a cylindrical passage that receives a hinge pin. In this way, the door is free to rotate about its hinges from an open to a closed position.

A conventional door assembly usually includes a door a door frame, and a hinge. The door would be attached to the door frame by the hinge. The door frame would include a jamb and a lip extending from an end of the jamb. The hinge would include two hinge plates, one attached to an edge of the door, while the other hinge plate is attached to a second end portion of the main jamb. The hinge plates would then be held together by a hinge pin

A gap would be formed between the lip of the door frame and the edge of the door. It is common for fingers to be caught or trapped in the gap when the door is maneuvered from an open position to a closed position, causing serious bodily injury. Other objects may also be caught in the space and damaged as a result.

There have been prior attempts to resolve this possible hazard, for example in U.S. Pat. No. 4,878,267. However, the method used consisted of inserting a device within the gap formed between the lip of the door frame and the edge of the door to resist entry of a foreign object. Such devices are awkward and unsightly, and require an additional cost on the part of the user.

Further, it can be noted that, for conventional door assemblies, with the door open, the door is not flushed with the door frame, but protrudes by a distance. Moreover, unsightly hinge plates are often exposed to view. This presents an inelegant appearance. Aesthetic features of a door assembly are significant in the furniture industry.

In view of the foregoing shortcomings, notably the problem of foreign objects or fingers being caught in the gap, or the door not being flushed to the frame, it is advantageous to provide a door assembly having a door attached to a door frame with a hinge which is created to overcome or at least reduce the foregoing shortcomings, and to provide the public with a positive decision.

### SUMMARY OF THE INVENTION

According to an aspect of the invention, there is provided a door assembly, comprising, in combination, a door frame suitable for receiving a door panel, the door frame having a door jamb at which a door panel is received, the door jamb comprising a lip extending perpendicularly from an end portion of the door jamb, a pivoting member onto which the door panel is pivotally connectable, wherein the pivoting member is attached to the lip of the door jamb.

According to an another aspect, there is provided a door assembly, comprising a door frame, a door panel pivotally connected to the door frame, suitable for movement from a first opened position to a second closed position, wherein the door panel and the door frame present an aligned plane in the opened position.

### DESCRIPTION OF THE FIGURES

FIGS. 1a and 1b show cross-sectional views of a door assembly in accordance with one embodiment of the invention, with the door in (a) open and (b) closed positions;

FIGS. 1c and 1d show cross-sectional views at the main jamb of a door assembly in accordance with the embodiment of FIG. 1a, with the door in (c) open and (d) closed positions;

FIGS. 2a and 2b show plan views, from the viewpoint of a person outside a room, of the door assembly in accordance with one embodiment of the invention, with the door in (a) open and (b) closed positions;

FIGS. 3a and 3b show plan views, from the viewpoint of a person inside a room, of the door assembly in accordance with one embodiment of the invention, with the door in (a) open and (b) closed positions;

FIG. 4 shows a perspective view, from the viewpoint of person outside a room, of the door assembly in accordance with one embodiment of the invention with the door in an open position; and

FIG. 5 shows a perspective view, from the viewpoint of person inside a room, of the door assembly in accordance with one embodiment of the invention with the door in an open position;

### DESCRIPTION OF THE PREFERRED EMBODIMENTS

The present invention relates to a door assembly comprising a door attached to a door frame by means of a pivoting member. The door assembly allows the door to be flush with the door frame when the door is in an open position. In one embodiment, at least part of the hinge is concealed from view when the door is in an open position. In one embodiment, the door arrangement substantially eliminates the gap formed between the door frame and an adjacent edge of the door when the door is open.

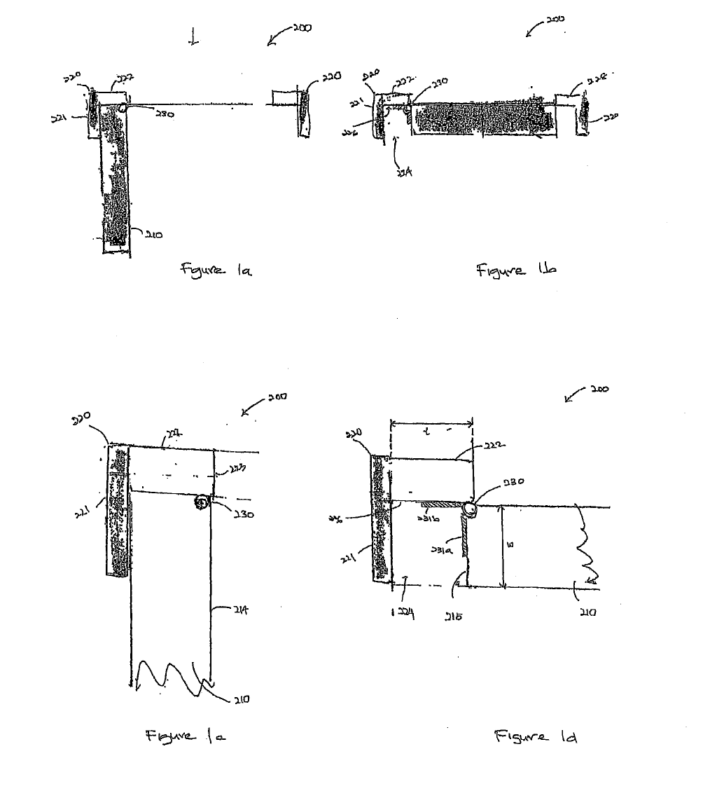

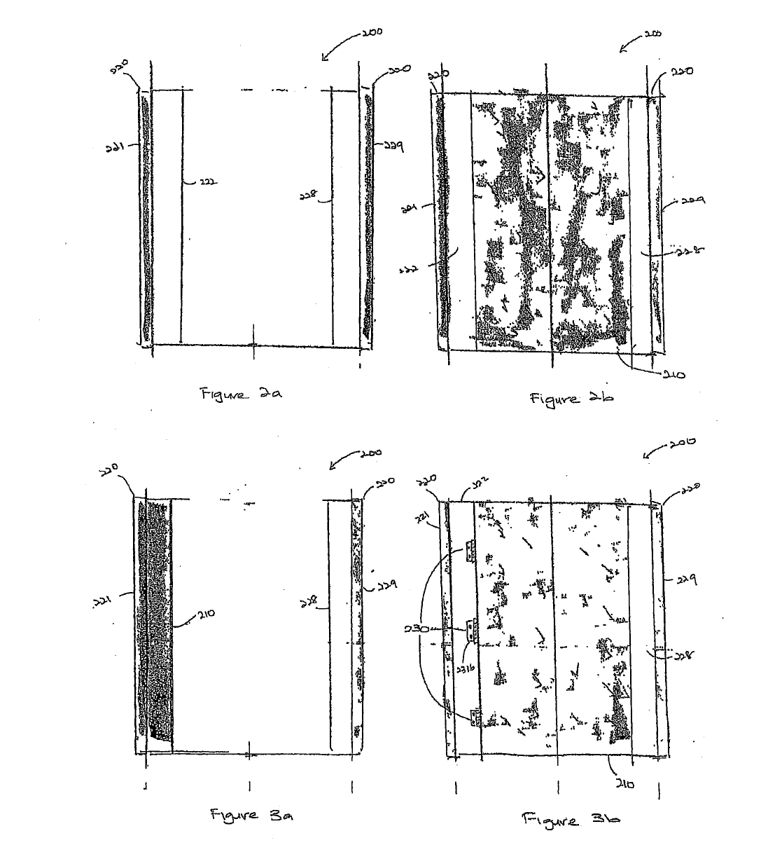

FIGS. 1a and 1b show cross-sectional views of a door assembly in accordance with one embodiment of the invention. FIG. 1a shows the door assembly with the door open, while FIG. 1b shows the door assembly with the door closed. In one embodiment, the door opens inwardly into a room. In such case, a person standing at the side of the door shown in FIG. 1a will be standing inside the room. In an alternative embodiment, the door opens outwardly such that a person standing at the side of the door will be standing outside the room.

As shown, the door assembly 200 comprises a door 210, a door frame 220, and a pivoting member 230. The door frame 220 is suitable for receiving a door 210, and includes a main jamb 221 at which the door is received. The main jamb 221 includes a lip 222 extending perpendicularly from an end portion of the main jamb 221.

The door 210 is pivotally connected to the door frame 220 by the pivoting member. The pivoting member may be a conventional hinge, a butterfly hinge, a strip hinge, an elongated hinge, a bi-fold hinge, a spring hinge, a concealed hinge, a ball-socket joint or any other type of pivoting element. It may also be noted that the pivoting member may be singular or may be composed of multiple elements, each being of the same variety or otherwise. For the purposes of this embodiment, a conventional hinge is used, three numbers of which are used in attaching the door panel to the door frame. The pivoting member 230 is connected to the lip 222 extending from an end portion of the main jamb 221.

Referring to FIG. 1b, the door frame comprises a recess 224 to provide a space for receiving an edge of the door when it is in an open position. The recess 224 is formed within the faces of the main jam 221, the lip 222 and the hinged edge 215 of the door. The recess 224 defines a recessed face 226 of the door frame 220. It may also be noted that the opposing door jamb 229 may also have a lip 228 to receive the door 210 when closed.

FIGS. 1c and 1d show close-up cross-sectional views at the main jamb of the door assembly of the embodiment of FIGS. 1a and 1b, with the door in the open and closed positions, respectively.

Referring to FIG. 1c, when the door is in an open position, the hinged edge of the door is received in the recess 224 of the door frame 220. As shown in FIG. 1c, an outer face 214 of the door is substantially flushed with the edge 223 of the lip 222 of the door frame, presenting an aligned plane when the door is in an open position.

As shown in FIG. 1d, the pivoting member 230 comprises first and second hinge plates 231a, 231b and a hinge pin 232. The first hinge plate 231a is attached to a hinged edge 215 of the door 210, while the second hinge plate 231b is attached to the recessed face 226 of the door frame 220. The hinge plates are also preferably concealed from the view of a person standing near or in the doorway. This achieves a neat appearance.

FIG. 1d also shows the lip 222 having a length l, and the door 210 having a width w. It is preferred that the length l of the lip 222 be at least the same or larger than the width w of the door 210. This is so that the hinged face 215 of the door 210 is able to substantially abut the recessed face 226 of the door frame. This also provides recess 224 to be of a large enough area to accommodate the door 210 when the door assembly 200 is in the opened position, and allow the outer face 214 of the door to be substantially flush with the door frame 220.

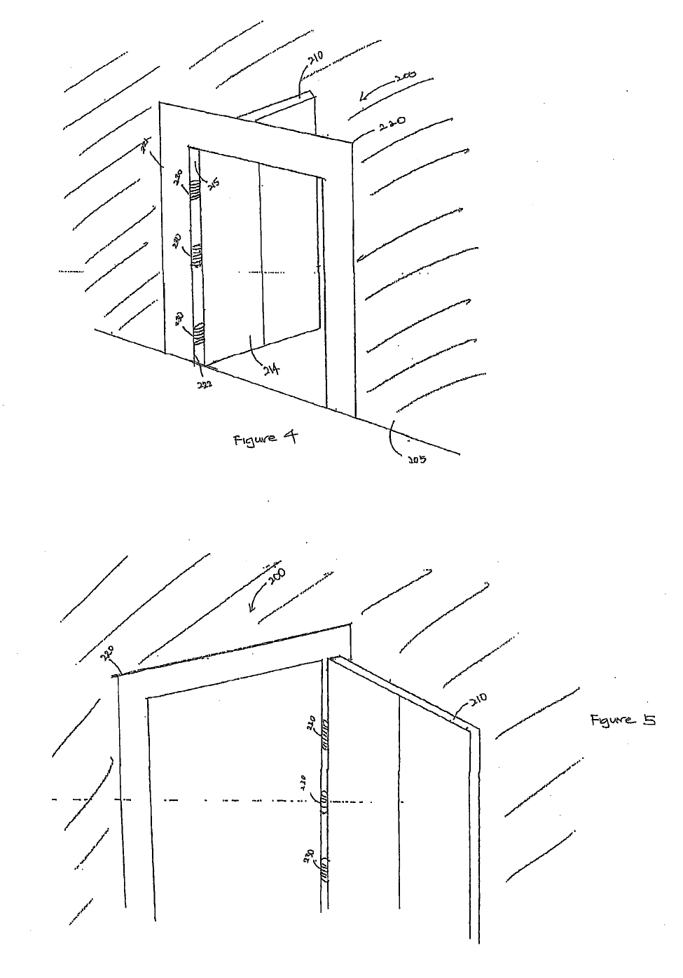

This feature, in the exemplary embodiment of FIG. 2, is more clearly illustrated in FIGS. 3-4. In the door assembly 200, the door 210 is shown to be attached to the door frame 220 by pivoting members 230, which are provided in this embodiment in the form of three hinges. Additionally, the door is assumed to be an inwardly opening door which opens into a room.

FIGS. 2a and 2b show plan views of the door assembly in accordance with the exemplary embodiment of the invention from the direct perspective of a person outside a room. FIG. 2a illustrates a door assembly with the door being opened, while FIG. 2b illustrates a door assembly with the door being closed. In such case, as shown in FIG. 2a, a person standing outside the room will preferably not be able to see the pivoting members 230, as they would be concealed behind the lip 222 from such a perspective. The person standing outside the room when the door is closed would preferably only see the door frame 220 of the door assembly 200, as the open face of the door 214 would be in the same plane as the edge 223 of the lip 222.

A person standing outside the room when the door has been closed, in the case as shown in FIG. 2b, will preferably only be able to see the door frame 220 of the door assembly 200, as well as the closed door 210.

FIGS. 3a and 3b show plan views of the door assembly in accordance with the exemplary embodiment of the invention from the direct perspective of a person inside a room. FIG. 3a illustrates a door assembly with the door being opened, while FIG. 3b illustrates a door assembly with the door being closed. As shown in FIG. 3a, a person standing inside the room with the door closed would preferably not be able to see the hinge as such a view would be obstructed by the door 210.

As shown in FIG. 3b, a person standing inside the room with the door closed will see the pivoting members 230 which engage the door 210 onto the lip 222 which extends perpendicularly from an end portion of the main jamb 221 of the door frame 220. The hinge plate face 231b would also be seen from such a perspective.

As shown in FIGS. 2b and 3b, the door 210 may also possibly be made out of two panels, instead of being a conventional solid door, and could integrate divider assembly elements within the structure to form an accordion door. It may also be possible that the door 210 could be of a sliding variety, wherein a single panel slides over another. Other possibilities for the door may also be possible.

FIGS. 4 and 5 show perspective views of the door assembly in accordance with an embodiment of the invention, with the door in an open position. FIG. 4 shows a door assembly 200 being inset into a wall 205, having a door frame 220. The door frame 220 having a main jamb 221 at which a lip 222 extends perpendicularly. The lip 222 is shown to be extending from the jamb 221 in the same plane as the wall 205. It would be preferable that the lip 221 is flush with the wall 205.

Pivoting members 230 are attached on one end to the lip 221 and the other end to a hinged edge 215 of the door 210. It may be seen that it is desired for the pivoting members to be inset into the plane formed by the lip 221 and the open face 214 of the door. This allows for the flushness of the open face 214 with the edge 223 of the lip of the door frame.

As for FIG. 5, it shows the door assembly from the perspective of a person standing in the room. As shown in FIGS. 4 and 5, only the hinge pins 230 may be seen, but the hinge plates will not be visible to such a person.

As an advantageous additional point, unlike conventional arrangements, no gap is formed between the door frame and the hinged edge of the door. This ameliorates the risk of getting a foreign object or a body part caught between the door and the door frame. It may be foreseen in other embodiments that the pivoting members may be inset into the lip of the door frame, or in the door itself, leading to a fully flushed plane formed by the open plane of the door and the edge of the lip of the door frame, wherein the door is directly abutting the door frame when open.

It will be understood that various changes in the details, materials and arrangements of parts which have been herein described and illustrated in order to explain the nature of the invention, may be made by those skilled in the art within the principle and scope of the invention. For example, the arrangement may be applied to a window. Providing an outwardly opening door is also useful.

1. A door arrangement comprising, in combination:
a door moveable from a closed position to an open position, the door having an outer face;
a door frame at least partially surrounding the door when the door is in the closed position, comprising a door jamb and a lip, wherein the lip extends generally perpendicular to the door jamb and the outer face of the door is positioned generally parallel to the door jamb when the door is in the open position;
wherein the lip is generally parallel to the outer face of the door when the door is in the closed position; and
the door is pivotally connected to the lip, allowing the door to pivot between the closed position and the open position.

2. A door arrangement according to claim 1, further comprising at least one pivoting member, wherein the door lip has a recessed edge and the door has a hinged edge, and the at least one pivoting member connects the hinged edge of the door to the recessed edge of the door lip.

3. A door arrangement according to claim 2, wherein the pivoting member may be any one of a conventional hinge, a butterfly hinge, a strip hinge, an elongated hinge, a bi-fold hinge, a spring hinge, a concealed hinge, a ball-socket joint or any other type of pivoting element.

4. A door arrangement according to any of the preceding claims, wherein the pivoting member is inset into the door panel.

5. A door arrangement according to any of the preceding claims, wherein the pivoting member is inset into the lip.

6. A door arrangement according to any of the preceding claims, wherein the pivoting member is inset into the plane formed by the lip and an outer face of the door panel when the door is in an open position.

7. A door arrangement according to any of the preceding claims, wherein the lip has a length L and the door has a width w, and L is at least the same or larger than w.

8. A door arrangement according to any of the preceding claims, wherein the door panel may be part of any one of a conventional solid door, a divider assembly, an accordion door, a sliding door, or any other kind of door assemblies.

9. A door arrangement comprising, in combination:
a door moveable from a closed position to an open position, the door having an outer face;
a door frame at least partially surrounding the door when the door is in the closed position, comprising a door jamb and a lip having an edge, wherein the lip extends generally perpendicular to the door jamb and the outer face of the door is positioned substantially flush with the edge of the lip when the door is in the open position;
wherein the lip is generally parallel to the outer face of the door when the door is in the closed position; and
the door is pivotally connected to the lip, allowing the door to pivot between the closed position and the open position.

10. The door arrangement of claim 9 further comprising at least one pivoting member formed as a hinge having a first hinge plate and a second hinge plate, wherein the hinge is attached to a recessed face of the lip and a hinged face of the door, and further comprising a recess defined on three sides by the hinged face of the door, the recessed face of the lip and the door jamb, wherein the hinge is positioned in the recess.

11. The door arrangement of claim 10 wherein the hinged face of the door is substantially parallel to the recessed face of the lip when the door is in the open position, and the hinged face of the door is substantially perpendicular to the recessed face of the lip when the door is in the closed position.

12. The door arrangement of claim 10 wherein the hinge plates are positioned in the recess, the door is adapted to partially define a room, wherein one side of the door is outside the room and the opposite side of the door is inside the room, and the lip is positioned on the side of the door outside the room.

13. The door arrangement of claim 10 wherein the hinge plates are substantially parallel when the door is in the open position and substantially perpendicular when the door is in the closed position.
